(19) United States
(12) Patent Application Publication
(10) Pub. No.: US 2003/0124900 A1
(43) Pub. Date: Jul. 3, 2003

(54) Protective cover for electrical plug

(76) Inventor: Cornelius C. O'Malley, New Orleans, LA (US)

Correspondence Address: DAVID L. RAY, ATTORNEY AT LAW, 2051 SILVERSIDE DRIVE, SUITE 205, BATON ROUGE, LA, 70808, US

(21) Appl. No.: 10/370,233

(22) Filed: Feb. 20, 2003

Related U.S. Application Data
(63) Continuation of application No. 10/047,295, filed on Jan. 14, 2002.
Application No. 10/047,295 is a continuation of application No. 09/695,202, filed on Oct. 24, 2000, now abandoned.

(51) Int. Cl. H01R 13/58

(52) U.S. Cl. 439/451

(57) ABSTRACT

An electrical plug cover for protecting the male prongs of an electrical plug from bending or breaking during storage or shipment, the electrical plug cover including a cover body, the cover body being constructed from a rigid material, the cover body having a plurality of hollow chambers therein for receiving the prongs of a male electrical plug, the electrical cover body having a tether connected thereto for attachment to an electrical cord having a male electrical plug connected thereto.

### BACKGROUND OF THE INVENTION

1. Field of the Invention

The present invention relates to common male two prong and three prong electrical plugs utilized for connecting electrical cords extending from electrical appliances to electrical energy sources such as common electrical wall sockets. In particular, the present invention is related to devices for protecting the prongs of such electrical plugs from bending and breaking.

2. Description of the Related Art

Various devices and implements are known in the art for covering and connecting electrical components such as electrical plugs and connectors. See for example U.S. Pat. No. 2,751,566; 2,962,688; 3,287,687; 3,327,280; 3,519,977; 4,421,369; 4,648,667; 4,679,873; 4,957,445; 4,902,238; and 5,316,493. Related foreign art include Japan 55-163782; UK Patent Application GB 2 165 403 A; UK Patent Application GB 2 259 194 A; and French FR 2 723 476-A1.

The male prongs of electrical plugs are sometimes accidentally bent during storage and transport. Such bending may render the plug unusable, and the appliance to which the plug is attached cannot be utilized for its intended purpose. Quite commonly, when transporting hair dryers or electrical razors or the like in flexible bags and suitcases, the male electrical plugs of these devices are bent and the appliance is unusable when the traveler reaches his destination.

Furthermore, exposed electrical plugs can damage items with which they are packed. For example, clothing can be punctured or torn by exposed electrical plugs, and toiletry items such as toothpaste tubes may be punctured.

### SUMMARY OF THE INVENTION

It is an object of the present invention to provide a device for preventing male electrical plugs from being bent when the plug is not plugged into an electrical energy source.

In accordance with the present invention there is provided an electrical plug cover for protecting the male prongs of an electrical plug from bending or breaking during storage or shipment, the electrical plug cover including a cover body, the cover body being constructed from a rigid material, the cover body having a plurality of hollow chambers therein for receiving the prongs of a male electrical plug, the electrical cover body having a tether connected thereto for attachment to an electrical cord having a male electrical plug connected thereto.

### BRIEF DESCRIPTION OF THE DRAWINGS

FIG. 1 is shown a perspective view of the protective cover of the invention and a electrical plug aligned therewith;

FIG. 2 is a cross sectional view taken along lines 2-2 of FIG. 1;

FIG. 3 is a perspective view of an electrical plug connected to the protective electrical cover of the invention with the tether of the cover connected to the electrical cord leading to the plug;

FIG. 4 is a perspective view of a second embodiment of the electrical plug cover of the invention shown aligned with an electrical plug and having the tether connected to the electrical cord leading to the electrical plug; and

FIG. 5 is a side view, partly cut-away, of the electrical cover and plug of FIG. 4, with the plug inserted into the cover.

### DETAILED DESCRIPTION OF THE INVENTION

Referring now to the drawings, and in particular to FIGS. 1-3, there is shown the first embodiment of the electrical plug cover of the invention generally indicated by the numeral 10. Plug cover 10 has a rigid body 11. Rigid body 11 can be seen to have two hollow chambers 12 and 13 therein for receiving prongs 15 and 16. Prongs 15 and 16 are connected to the electrical plug generally indicated by the numeral 18 and are generally rectangular in shape.

Electrical plug 18 is a conventional electrical plug well known in the art. Electrical plug 18 has a conventional electrical power supply cord 20 connected thereto which extends to an appliance such as electrical razor, hair dryer or any other electrical appliance(not shown). Electrical plugs such as plug 18 are most commonly used on electrical appliances which are operated by alternating current electrical energy sources. However, plug 18 may also be used on appliances which utilize direct electric current.

As can be seen in FIG. 2, hollow chamber 13 and identical hollow chamber 12 are generally rectangular in cross-section and are adapted to receive prongs 15 and 16 force-fitted therein. Hollow chambers 12 and 13 may be increased or decreased in size as necessary to receive larger or smaller prongs 15 or 16. Also, one of the hollow chambers 12 or 13 may be larger than the other hollow chamber if one of the prongs 15 or 16 is larger than the other prong.

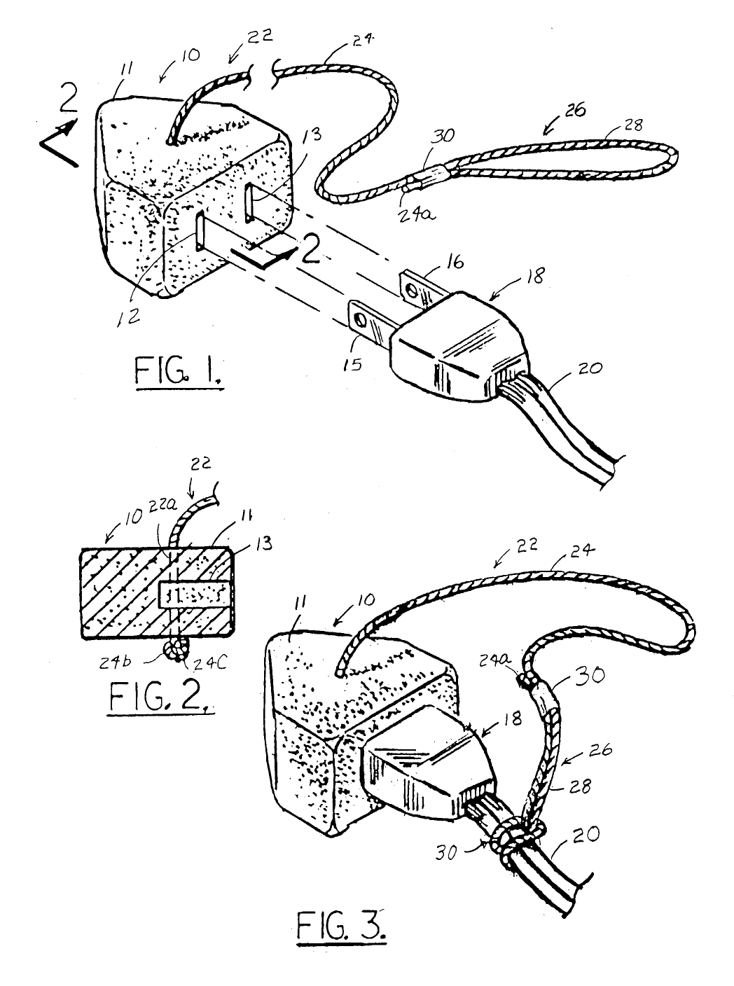

Body 11 has a tether generally indicated by the numeral 22 connected thereto. Tether 22 is preferably an elongated cord or line 24 which is connected at one end to body 11. At the other end of tether 22 is an attaching device generally indicated by the numeral 26 for attaching tether 22 to electrical cord 20 as shown in FIG. 3.

Line 24 may be made from natural or synthetic material or fibers, and may be woven or non-woven. Furthermore, line 24 could be made from flexible metal wire or woven from metal wires.

As shown in FIGS. 1 and 3, the attaching device 26 is preferably a loop generally indicated by the numeral 28 which is formed by extending the end 24a of line 24 to form loop 28, and attaching the end 24a of line 24 to line 24 with a fastener 30. Fastener 30 may be a metal sleeve which is crimped about end 24a and line 24 to connect them together. However, if desired, end 24a may be sealed to line 24 by any method or fastener known in the art, although fastener sleeve 30 is preferred. If desired, the end 24a could be bonded to line 24 by heat fusing, gluing, or the like. Exemplary of other suitable fasteners are spring loaded hooks and clips, or the like.

The other end of tether 22 is connected to body 11. In the embodiment shown in FIG. 2, a common knot 24b is tied at the end 24c of tether 22 after extending tether 22 through body 11. A channel 22a is formed in body 11 for snug receipt of line 24 of tether 22. After extending line 24 through channel 22a, knot 24b is tied at the end 24c of line 24 to prevent the end 24c from being pulled outwardly from body 11. In a like manner, if end knot 24b is pulled away from body 11, loop 28 and fastener 30 will prevent tether 22 from being removed from body 11 when they contact channel 22a.

A preferred method of attaching loop 28 to electrical cord 20 is illustrated in FIG. 3. Loop 28 is curled over itself as is known in the art to form a noose generally indicated by the numeral 30 in FIG. 3. Noose 30 is placed over plug 18 and tightened about electrical cord 20. As shown in FIG. 3, electrical plug 18 is received and protected in body 11, and tether 22 is fastened about electrical cord 20. In the configuration shown in FIG. 3, the prong 15 and 16 of electrical plug 18 are protected from bending or breaking during transported storage. As also shown in FIG. 3, body 11 is secured to cord 20 by tether 22 and will not be lost when plug 18 is removed from body 11 and inserted into an electrical energy source such as a wall socket.

The shape of body 11 may be selected as desired so long as the body 11 is long enough to receive prongs 15 and 16 and large enough for connection of tether 22 thereto. Body 11 may be made from any rigid material known in the art, such as styrofoam as shown in FIGS. 1-3. The material from which plug 10 is made may be a solid polymeric material, commonly referred to as plastics, or any other rigid or semi-rigid material known in the art.

Preferably hollow chambers 12 and 13 are sized so that prongs 15 and 16 must be forced fitted therein. Since prongs 15 and 16 are force-fitted into hollow chambers 12 and 13 of body 11, plug 18 will not fall from hollow chambers 12 and 13 without a force being exerted on plug 18 sufficient to remove plug 18 from body 11.

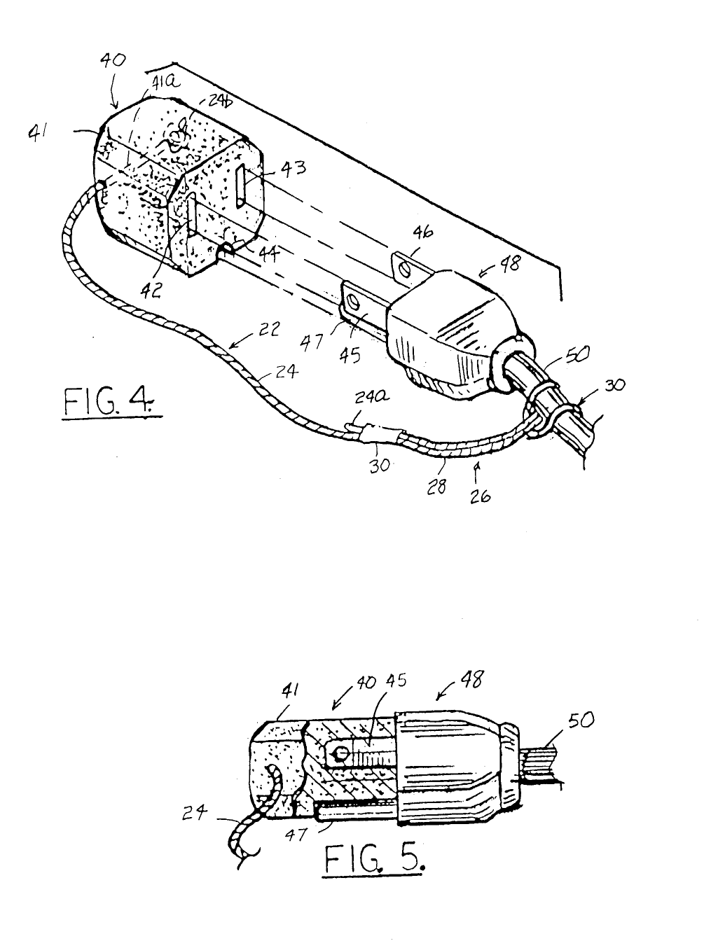

Referring now to FIGS. 4 and 5, there is shown a second embodiment of the electrical plug cover of the invention generally indicated by the numeral 40 for receipt of a three-pronged electrical plug. Plug cover 40 has a rigid body 41. Body 41 can be seen to have two hollow chambers 42 and 43 and a slot 44 therein for receiving prongs 45, 46, and 47, respectively. As is known in the art, prong 47 is utilized for a ground connection and prongs 45 and 46 are used to convey electrical energy. Prongs 45 and 46 are connected to the electrical plug generally indicated by the numeral 48.

Slot 44 is preferably semi-circular in cross-section as shown in FIG. 4. However, if desired, slot 44 could be circular in cross-section to completely enclose ground prong 47.

Electrical plug 48 is a conventional three prong electrical plug well known in the art Electrical plug 48 has a conventional electrical power supply cord 50 connected thereto which extends to an appliance such as electrical razor, hair dryer or any other electrical appliance(not shown). Electrical plugs such as plug 48 are most commonly used on electrical appliances which are operated by alternating current energy sources. However, plug 48 may also be used on appliances which utilize direct current.

As can be seen in FIG. 4, hollow chamber 42 and identical hollow chamber 43 are generally rectangular in cross-section and are adapted to receive prongs 45 and 46 force-fitted therein. Hollow chambers 42 and 43 may be increased or decreased in size as necessary to receive larger or smaller prongs 45 or 46. Also, one of the hollow chambers 42 or 43 may be larger than the other hollow chamber if one of the prongs 45 or 46 is larger than the other prong.

As shown in FIGS. 4 and 5, body 41 has a tether generally indicated by the numeral 22 connected thereto. Tether 22 is preferably an elongated cord or line 24 which is connected at one end to body 41. At the other end of tether 22 is an attaching device generally indicated by the numeral 26 for attaching tether 22 to electrical cord 50 as shown in FIG. 4.

As shown in FIGS. 4 and 5, the attaching device 26 is preferably a loop generally indicated by the numeral 28 which is formed by extending the end 24a of line 24 to form loop 28 and attaching the end 24a of line 24 to line 24 with a fastener 30. Fastener 30 may be a metal sleeve which is crimped about end 24a and line 24 to connect them together. However, if desired end 24a may be sealed to line 24 by any method or fastener known in the art, although sleeve 30 is preferred. If desired, the end 24a could be bonded to line 24 by heat fusing, gluing, or the like. Exemplary of other suitable fasteners are spring loaded hooks and clips, or the like.

The other end of tether 22 is connected to body 41. In the embodiment shown in FIG. 4, a common knot 24b is tied at the end of tether 22 after extending tether 22 through body 41. A channel 41a is formed in body 41 for snug receipt of line 24 of tether 22. After extending line 24 through channel 22a, knot 24b is tied at the end 24c of line 24 to prevent the end of line 24 from being pulled outwardly from body 41. In a like manner, if knot 24b is pulled away from body 41, loop 28 and fastener 30 will prevent tether 22 from being removed from body 41 when they contact channel 41a.

A preferred method of attaching loop 28 to electrical cord 20 is illustrated in FIG. 4. Loop 28 is curled over itself as is known in the art to form a noose generally indicated by the numeral 30 in FIG. 4 which is placed cover plug 48 and tightened about electrical cord 50. As shown in FIG. 5, electrical plug 48 is received and protected in body 41, and as shown in FIG. 5, tether 22 is fastened about electrical cord 50. In the configuration shown in FIG. 5, the prongs 45 and 46 of electrical plug 48 are protected from bending or breaking during transported storage. As also shown in FIG. 4, body 41 is secured to cord 50 by tether 22 and will not be lost when plug 48 is removed from body 41 and inserted into an electrical energy source such as a wall socket.

The shape of body 41 may be selected as desired so long as the body 41 is long enough to receive prongs 45, 46, and 47 and large enough for connection of tether 22 thereto. Body 41 may be made from any rigid material known in the art, such as styrofoam as shown in FIGS. 4-5. The material from which plug 40 is made may be a solid polymeric material, commonly referred to as plastics.

Preferably hollow chambers 42 and 43 are sized so that prongs 45 and 46 must be forced fitted therein. Since prongs 45 and 46 are force-fitted into hollow chambers 42 and 43 of body 41, plug 48 will not fall from hollow chambers 42 and 43 without a force being exerted on plug 48 sufficient to remove plug 48 from body 41.

Although the preferred embodiments of the invention have been described in detail above, it should be understood that the invention is in no sense limited thereby, and its scope is to be determined by that of the following claims:

What is claimed is:

1. An electrical plug cover for protecting the male prongs of an electrical plug from bending or breaking during storage or shipment, said electrical plug cover including a cover body, said cover body being constructed from a rigid material, said cover body having a plurality of hollow chambers therein for receiving the prongs of a male electrical plug, said cover body having a tether connected thereto for attaching said cover body to an electrical cord having a male electrical plug connected thereto.

2. The electrical plug cover of claim 1 wherein said chambers are sized to receive said prongs force-fitted therein.

3. The electrical plug cover of claim 1 wherein said chambers are generally rectangular in cross-section.

4. The electrical plug cover of claim 1 said plug cover is made from a rigid material.

5. The electrical plug cover of claim 1 wherein said plurality of chambers are two in number.

6. The electrical plug cover of claim 1 wherein said plurality of chambers are three in number.

7. The electrical plug cover of claim 1 wherein said tether has two ends, and one of said two ends is connected to said cover body.

8. The electrical plug cover of claim 8 wherein said end of said tether connected to said cover body is received in a channel in said cover body and has a knot in the distal end thereof to prevent said tether from sliding completely through said cover body.

9. The electrical cover of claim 8 wherein said tether has a loop in the other end thereof for connecting said tether to said electrical cord.
